(19) United States
(12) Patent Application Publication
(10) Pub. No.: US 2009/0248574 A1
(43) Pub. Date: Oct. 1, 2009

(54) PEER-TO-PEER CURRENCY EXCHANGE AND ASSOCIATED SYSTEMS AND METHODS

(76) Inventors: Florence F. L. Leung, Richmond (CA); Parham Yaghoobi, Vancouver (CA); Lewis John Zimmerman, Vancouver (CA); Robert Geoffrey Hugh Dunlop, Calgary (CA); Grant Ringham, Vancouver (CA)

Correspondence Address: PERKINS COIE LLP;PATENT-SEA, P.O. BOX 1247, SEATTLE, WA, 98111-1247, US

(21) Appl. No.: 12/058,454

(22) Filed: Mar. 28, 2008

(51) Int. Cl. G06Q 40/00

(52) U.S. Cl. 705/39

(57) ABSTRACT

Peer-to-peer currency exchanges and associated systems and methods are disclosed herein. In one embodiment, a computer-implemented method of facilitating a currency exchange transaction between multiple users of a peer-to-peer currency exchange system can include receiving user instructions at the currency exchange system for a currency exchange transaction. The method can also include funding corresponding user accounts at the currency exchange system based on the respective user's selected amount of money to be converted and a current exchange rate between the first currency and the second currency. The method can further include aggregating funds from the corresponding user accounts at the system and, after aggregating the funds, matching user requests for a conversion of funds into a selected currency pairing. The matching process is based, at least in part, on one or more predetermined matching parameters. The method can also include transferring the converted funds to a corresponding external account of the respective user.

### TECHNICAL FIELD

The following disclosure relates generally to peer-to-peer currency exchange and associated systems and methods.

### BACKGROUND

To exchange currency, a person typically walks into a bank or approaches a currency exchange kiosk at an airport, railway station, or the like, and completes the transaction. For example, upon arrival in a foreign country, an international traveler may use such an exchange to obtain local currency with which to conduct transactions during his or her trip. At the end of the traveler's stay in the particular country, the traveler may again use such an exchange to convert any excess funds in the local currency back into the currency of the traveler's home country or region. In another example, a company located in a first country (e.g., Canada) may conduct a significant amount of business with one or more companies (e.g., suppliers, vendors, etc.) in a second country (e.g., the United States), and may need to exchange currency on a regular basis to make payments to the one or more companies in the second country.

Although conventional currency exchange methods are readily available, the transaction fees associated with such exchanges can be very high. For example, although currency exchange rates vary, it is not uncommon for such fees to be as much as 3% for each transaction. For individuals or businesses who conduct a large number of currency exchange transactions, the total cost of such fees can be significant.

### BRIEF DESCRIPTION OF THE DRAWINGS

FIG. 1 is a block diagram of a basic and suitable computer that may employ aspects of the disclosure.

FIG. 2 is a block diagram illustrating a computing environment suitable for implementing a peer-to-peer currency exchange system and method in accordance with embodiments of the disclosure.

FIG. 3 is a block diagram illustrating components of a peer-to-peer currency or value exchange system configured in accordance with an embodiment of the disclosure.

FIG. 4 is a flow diagram illustrating a method for opening a new account with a currency exchange system in accordance with an embodiment of the disclosure.

FIGS. 5A-5C are screen displays illustrating representative Web pages for various aspects of the method of FIG. 4

FIG. 6 is a flow diagram illustrating a method for conducting a currency exchange transaction between two or more persons or other entities via peer-to-peer trading in accordance with an embodiment of the disclosure.

FIGS. 7A and 7B are screen displays illustrating representative Web pages for various aspects of the method of FIG. 6.

FIG. 8 is a block diagram illustrating data flow between various components of a P2P currency or value exchange system in some embodiments.

FIG. 9 is a block diagram illustrating data flow between various components of a P2P currency or value exchange system in some embodiments.

### DETAILED DESCRIPTION

The following disclosure is directed generally to peer-to-peer (P2P) currency exchange and associated systems and methods. Aspects of the disclosure, for example, are directed to matching buyers and sellers of currency directly to facilitate currency exchange transactions between users of the currency exchange system. In this way, the currency exchange system can avoid the currency carrying risks associated with many conventional exchange dealers and provide conversions at or around the median of the bid-spread rate, which is significantly lower rate than most conventional currency exchanges.

As described in greater detail below, one feature of various embodiments of the system and methods described below is that, in almost all situations, the currency exchange system can complete currency exchanges for the users of the system in a timely and predictable manner regardless of demand imbalances during any given processing cycle. The foreign exchange market is a highly dynamic and volatile market. Various embodiments of the currency exchange systems and associated methods in this disclosure, however, are expected to provide users with a single entity that can handle foreign currency exchange needs for a disparate group of users in an efficient, low-cost, and secure manner.

One aspect of the disclosure is directed toward a computer-implemented method for facilitating a currency exchange transaction between multiple users of a computerized peer-to-peer (P2P) currency exchange system. The method can include receiving user instructions at the currency exchange system for a currency exchange transaction. The individual user instructions can include (a) a selected amount of money to be converted, (b) specification of a first currency in which the funds in which the funds are to be provided, (c) specification of a second currency different from the first currency into which the funds are to be converted, and (d) specification of a period of time in which the transaction is to be completed. The method can also include funding corresponding user accounts at the currency exchange system based, at least in part, on the respective user's selected amount of money to be converted and a current exchange rate between the first currency and the second currency. The method can further include aggregating funds from the corresponding user accounts at the currency exchange system. After aggregating the funds, the method can also include matching user requests for a conversion of funds into a selected currency pairing. The matching process is based, at least in part, on one or more predetermined matching parameters. The method can further include, for each matched user request, electronically transferring the converted funds to a corresponding external account of the respective user.

In another aspect of the disclosure, a peer-to-peer currency exchange system for facilitating foreign currency exchange transactions between multiple users can include one or more data storage components configured to store user account information, user instructions for currency exchange transactions, and one or more predetermined transaction matching parameters. The currency exchange system can also include one or more data processing components coupled to the one or more data storage components. The data processing component(s) can be configured to process user instructions for currency exchange transactions. The individual user instructions include a selected amount of money to be converted from a first currency to a second, different currency and a time period in which the transaction is to be completed. The data processing component(s) can also be configured to debit funds from one or more external financial accounts of each user to fund the respective user's account at the currency exchange system. The data processing component(s) can further be configured to group the user requests and funds from corresponding user accounts, and match two or more of the grouped user requests for a conversion of funds into a selected currency pairing. The matching process can be based, at least in part, on the one or more predetermined transaction matching parameters. The data processing component(s) can further be configured to disburse the converted funds to a corresponding external financial account of the corresponding user.

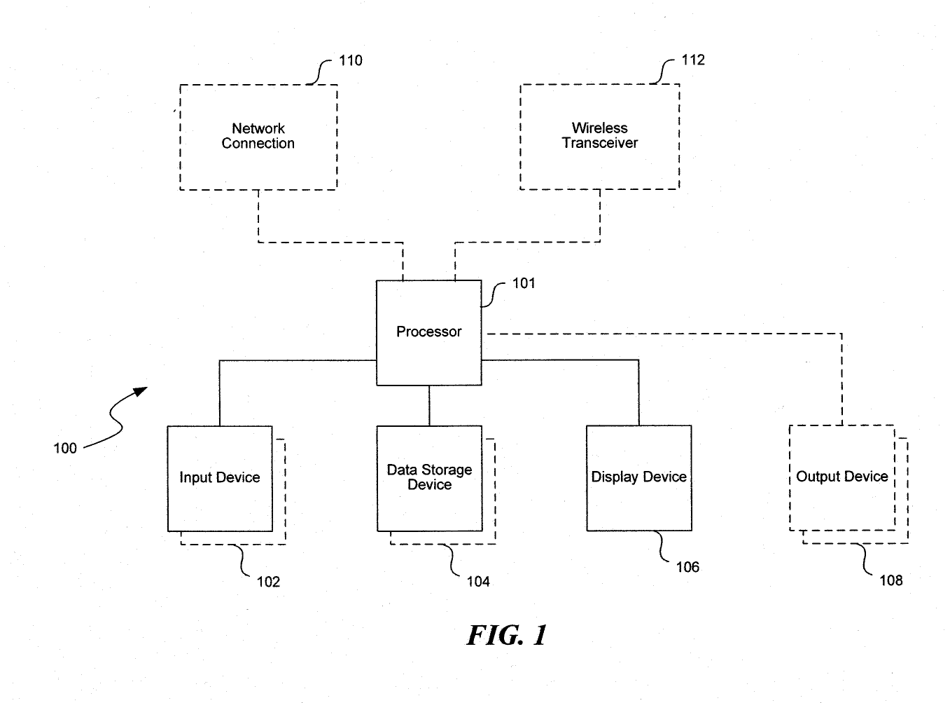

Certain specific details are set forth in the following description and FIGS. 1-9 to provide a thorough understanding of various embodiments of the disclosure. Well-known structures, systems, and methods associated with such systems have not been shown or described in detail to avoid unnecessarily obscuring the description of the various embodiments of the disclosure. In addition, those of ordinary skill in the art will understand that various embodiments of the disclosure may be practiced without several of the details described below.

The terminology used in the description presented below is intended to be interpreted in its broadest reasonable manner, even though it is being used in conjunction with a detailed description of certain specific embodiments of the disclosure. Certain terms may even be emphasized below; however, any terminology intended to be interpreted in any restricted manner will be overtly and specifically defined as such in this Detailed Description section.

### A. Suitable Computing Environments in Which Aspects of the Disclosure can be Implemented

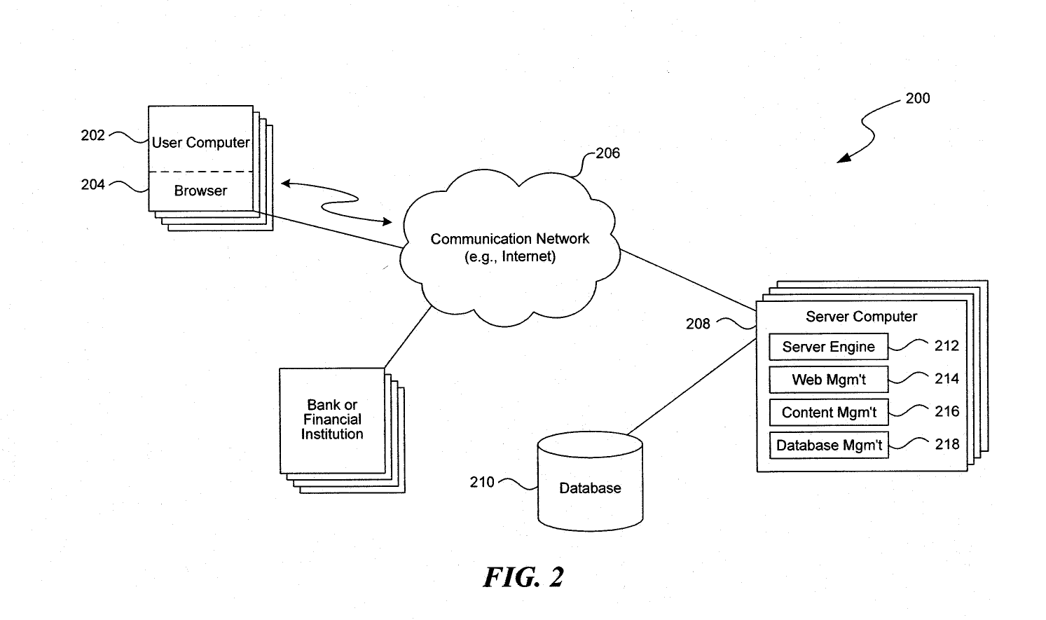

FIGS. 1 and 2 and the following discussion provide a brief, general description of a suitable computing environment in which aspects of the disclosure can be implemented. Although not required, aspects and embodiments of the disclosure will be described in the general context of computer-executable instructions, such as routines executed by a general-purpose computer, e.g., a server or personal computer. Those skilled in the relevant art will appreciate that the disclosure can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. Several embodiments of the disclosure can be embodied in a special purpose computer or data processor that is specifically programmed, configured, or constructed to perform one or more of the computer-executable instructions explained in detail below. Indeed, the term “computer”, as used generally herein, refers to any of the above devices, as well as any data processor.

Several embodiment of the disclosure can also be practiced in distributed computing environments, where tasks or modules are performed by remote processing devices, which are linked through a communications network, such as a LAN, WAN, or the Internet. In a distributed computing environment, program modules or sub-routines may be located in both local and remote memory storage devices. Aspects of the disclosure described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that aspects of the disclosure may reside on a server computer, while corresponding portions reside on a client computer. Data structures and transmission of data particular to aspects of the disclosure are also encompassed within the scope of the disclosure.

Referring to FIG. 1, one embodiment of the disclosure employs a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer 100 may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 1).

As mentioned above, aspects of the disclosure may be practiced in a variety of other computing environments. Referring to FIG. 2, for example, a distributed computing environment includes a system 200 having one or more user computers 202, one or more banks or financial institutions 230, and at least one server computer 208 interconnected via a communication network 206 (e.g., the Internet). The individual user computers 202 can each include a client application, such as a browser program module 204 that permits the computer to access and exchange data with a communication network 206 (e.g., the Internet), including Web sites within the World Wide Web portion of the Internet (although other networks and network access applications may of course be employed). The user computers 202 may be substantially similar to the computer 100 described above with respect to FIG. 1. User computers 202 may include other program modules such as an operating system, one or more application programs (e.g., word processing or spreadsheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below. The use of a web browser and web interface are only used as a familiar example here.

The server computer(s) 208 coupled to the network 206 performs much or all of the functions for receiving, routing and storing of electronic messages, which may at times include web pages, audio signals, and electronic images. While the Internet is shown in the illustrated embodiment, a variety of different types of networks, such as an intranet, an extranet, virtual private network (VPN), a non-TCP/IP based network, or the like, may be preferred in some applications. The network 206 may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the web pages and content exchanged between the user computers 202. The server computer(s) 208, including the database(s) 210, may employ security measures to inhibit malicious attacks on the system 200, and to preserve integrity of the messages and data stored therein (e.g., firewall systems, secure socket layers (SSL), password protection schemes, encryption, and the like).

The server computer 208 may include a server engine 212, a web page management component 214, a content management component 216 and a database management component 218. The server engine 212 performs basic processing and operating system level tasks. The web page management component 214 handles creation and display or routing of web pages. Users may access the server computer 208 by means of a URL associated therewith. The content management component 216 handles most of the functions in the embodiments described herein. The database management component 218 includes storage and retrieval tasks with respect to the database 210, queries to the database 210, and storage of data such as video, graphics and audio signals. Importantly, the server computer 208 may obtain data from other computers (and their associated databases), including other server computers (not shown).

In embodiments including multiple servers 208, a load balancing system (not shown) may be employed to balance load(s) on the server computers. Load balancing is a technique well-known in the art for distributing the processing load between two or more computers, to thereby more efficiently process instructions and route data. Such a load balancer can distribute message traffic, particularly during peak traffic times. A distributed file system may also be used in such embodiments to couple the servers to multiple databases. A distributed file system is a type of file system in which the file system itself manages and transparently locates pieces of information (e.g., content pages) from remote files or databases and distributed files across the network, such as a LAN. The distributed file system also manages read and write functions to the databases. In other embodiments, the computing environments described above can have other arrangements, including more, fewer, and/or different components.

### B. Embodiments of Peer-to-Peer Currency Exchange Systems and Associated Methods

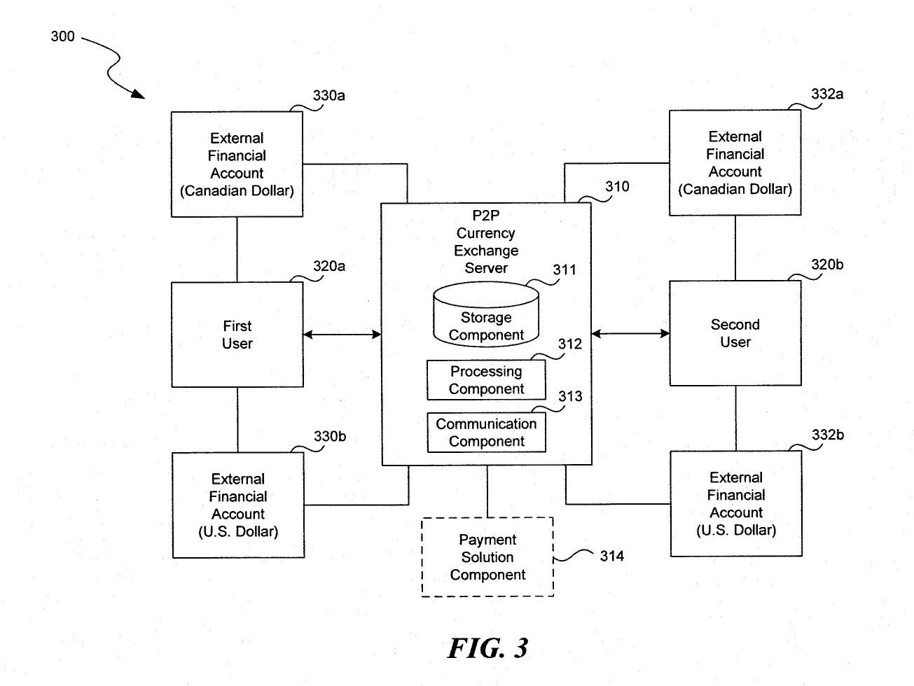

FIG. 3 is a block diagram illustrating the interaction and data flow between various components of a P2P currency exchange system 300 configured in accordance with an embodiment of the disclosure. The system 300 can be used for conducting a currency or value exchange transaction between two or more persons or other entities via peer-to-peer trading. The system 300 can include a number of computer components having features generally similar to the computer and network components described above with reference to FIGS. 1 and 2.

The system 300 can include, for example, a currency exchange or fund exchange server 310 having a storage component 311 configured to store various information used to facilitate currency exchange transactions. The information can include, for example, personally identifying information for registered users of the system (e.g., name, company name, address, telephone number(s), electronic mail address, etc.), financial information for registered users (e.g., bank or financial institution account information, transaction preferences, etc.), transaction records, account balances, security data, and the like.

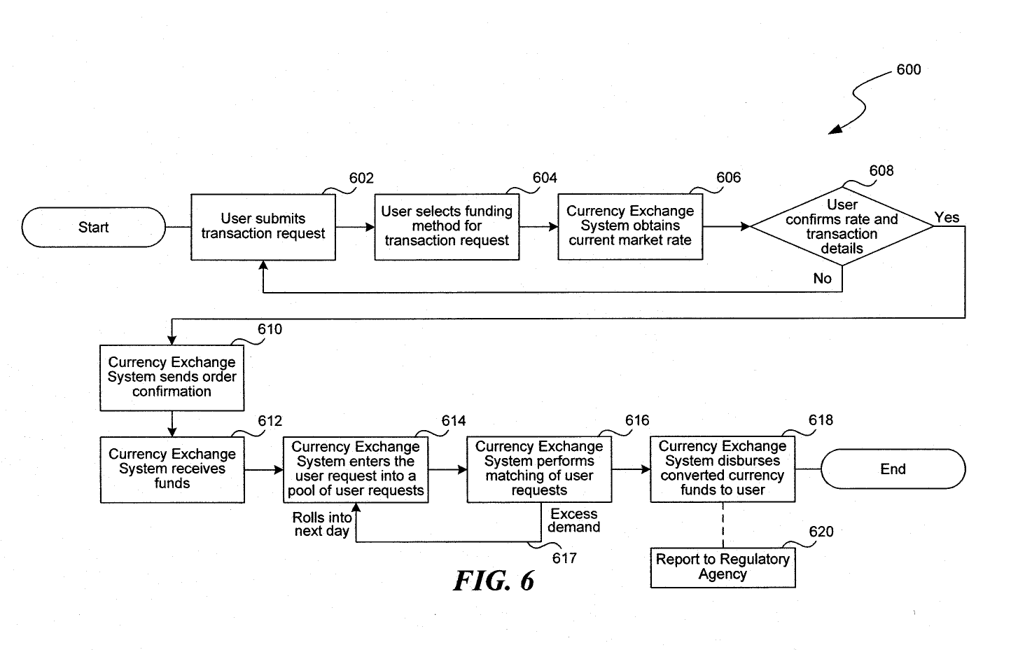

The currency exchange server 310 can also include a processing component 312 configured to receive and confirm transaction details from registered users, and process such transactions. As described in greater detail below with reference to FIG. 6, the processing component can match and optimize all the currency exchange transaction requests from the users, and disburse funds from the completed transactions into external accounts of the corresponding users.

The currency exchange server 310 can also include a communication component 313 that handles communication between the server and various system components that interact with the server via the network. For example, the communication component 313 can handle hosting and routing of web pages associated with various aspects of the currency exchange system and method. Although only a single currency exchange server 310 is shown, it should be understood that more than one currency exchange server may be used, either individually or in a distributed manner, and that other servers providing additional functionality may also be interconnected to any component shown in the system 300 either directly or over a network.

The system 300 may also include a payment solution component 314 configured to disburse funds to individual users after completion of each conversion transaction. The payment solution component 314 may be an integral component of the currency exchange server 310, or the payment solution component 314 may be an external entity interconnected with the currency exchange server 310. Suitable external commercial payment solution providers include, for example, hyperWALLET Systems Inc. of Vancouver, British Columbia, or Paystone Technologies Corp. of Vancouver, British Columbia. The payment solution component 314, however, is an optional component that may not be included within the system 300 in certain embodiments.

The system 300 can also includes two or more users 320 (two are shown as a first user 320a and a second user 320b) interacting with the currency exchange server 310. The users 320 can include individuals (e.g., travelers, international students, etc.), businesses, or any of a variety of different entities wishing to exchange currency. The first and second users 320a and 320b can use any of a variety of different client devices to interact with the currency exchange server 310. The client devices can include a personal desktop computer, workstation, kiosk, cellular telephone, personal digital assistant (PDA), laptop, or any other device capable of interfacing directly or indirectly with the currency exchange server 310 via a network. As described previously, for example, the client devices can run a browser program module (e.g., Microsoft's Internet Explorer, Mozilla's Firefox, or the like, or a microbrowser such as a WAP enabled browser in the case of a cell phone, PDA or other handheld wireless devices) that permits the device to access and exchange data with the currency exchange server 310 via the network, and browse pages and forms provided by the currency exchange server 310. In other embodiments, the users 320 may interact with the currency exchange server 310 using other suitable methods and/or systems. Moreover, although only two user devices 320a and 320b are shown, it will be appreciated that more than two user or client devices 320 may be interconnected to the currency exchange server 310.

The first and second users 320a and 320b can link their respective accounts at the currency exchange server 310 with external bank or financial accounts (e.g., checking or savings account, credit card account, bill payment account, brokerage account, a service such as PayPal® or some other electronic fund transfer system, or the like). In the embodiment illustrated in FIG. 3, for example, the first user 320a has linked a first bank account 330a and a second bank account 330b with the first user's account at the currency exchange server 310. The first bank account 330a is a Canadian dollar account, and the second bank account 330b is a U.S. dollar account. The first and second bank accounts 330a and 330b may be at different banks or financial institutions, or the accounts may be separate accounts with the same bank or financial institution. The second user 320b also has linked a first bank account 332a (e.g., a Canadian dollar account) and a second bank account 332b (a U.S. dollar account). In other embodiments, a different number of accounts may be linked with the corresponding user accounts. Furthermore, the individual bank accounts can be based on any type of currency, and are not limited to Canadian and/or U.S. dollar accounts.

The system 300 may also include a number of security features to ensure and enforce security for currency exchange transactions and actions related to such transactions. In several embodiments, for example, suitable encryption techniques may be used to encrypt communications between the individual system components. In addition, the entity operating the system 300 may conduct a security audit to ensure that the system configuration adheres to established security guidelines for foreign currency exchange transactions. The system 300 can also include a number of tracking and reporting features to ensure that the system complies with local, national, and international guidelines governing foreign currency exchange transactions. Each of the security and reporting components can be readily updated and/or modified as the need arises so the system 300 can maintain compliance with all necessary regulations.

For purposes of brevity and clarity, the block diagram of FIG. 3 is referred to in its entirety as illustrating a currency exchange system 300. It will be appreciated, however, that this description may also be applied to various individual components or subsets of components of the block diagram of FIG. 3. Furthermore, the arrangement of the various components in the system 300 is merely intended to demonstrate one possible architecture of a currency exchange system configured in accordance with aspects of the disclosure. In several embodiments, for example, the currency exchange system 300 may be a subcomponent of, linked with, or otherwise associated with a larger electronic commerce system (e.g., an e-commerce Web site, a travel Web site, a financial institution Web site, etc.). In still other embodiments, the system 300 can have a variety of other arrangements and/or features.

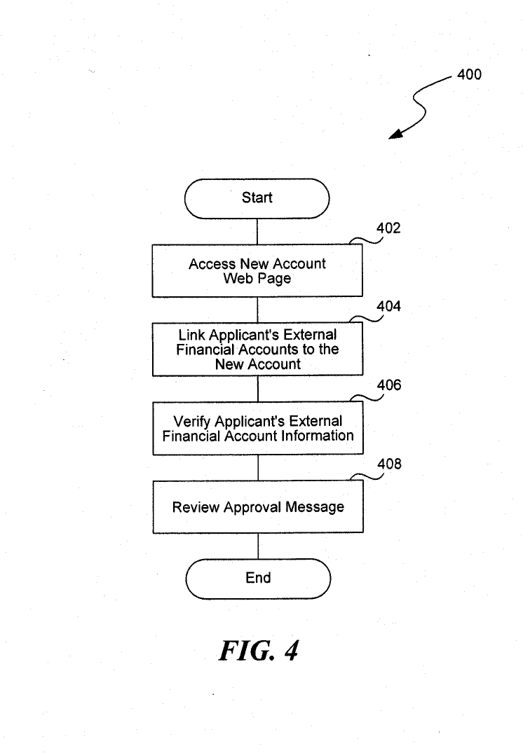

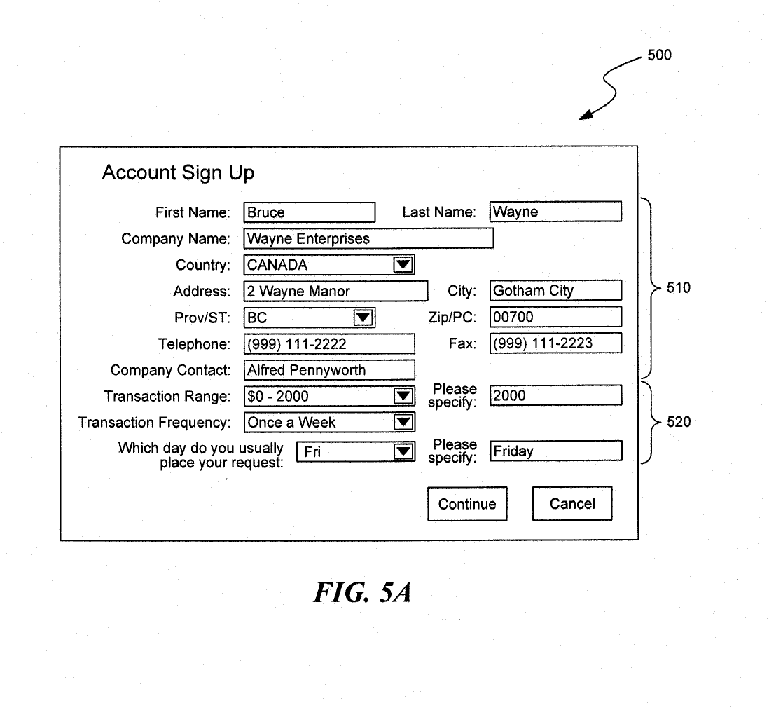

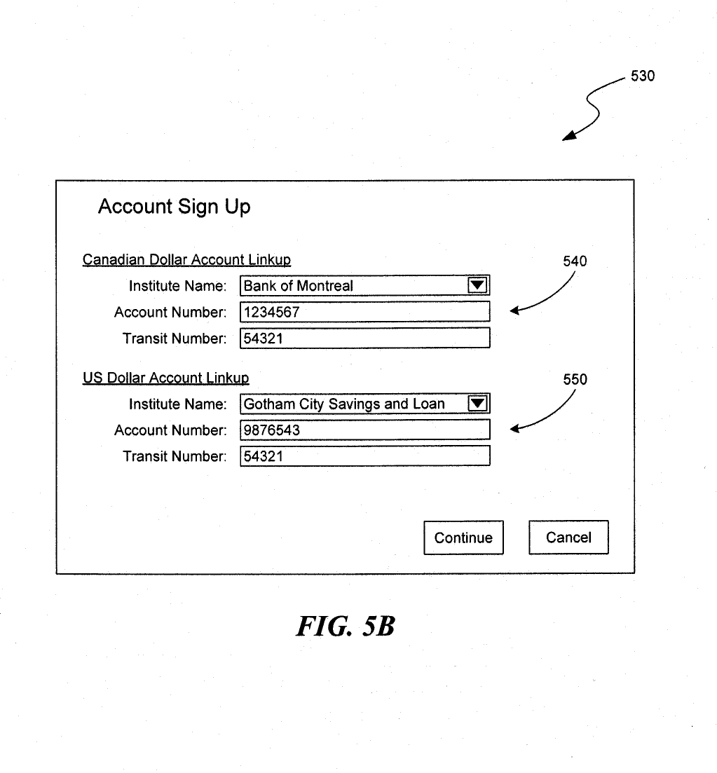

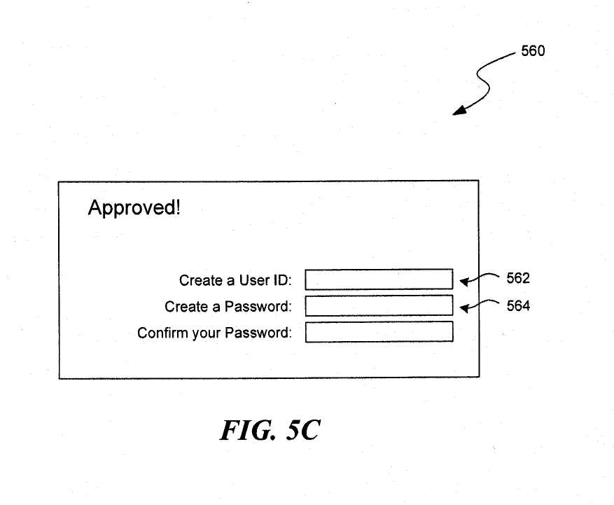

FIG. 4 is a flow diagram illustrating a method or routine 400 for opening a new account with a currency exchange system in accordance with an embodiment of the disclosure. In one aspect of this embodiment, the method 400 can be at least partially performed by an applicant from a remote location (e.g., the applicant's home computer). In one aspect of this embodiment, some portions of the method 400 may be performed by an applicant from a remote location (e.g., the applicant's home computer), and other portions may be performed by a currency exchange system. In other embodiments, however, various portions of the method 400 can be performed by other entities using other networked or non-networked devices to open the account with the currency exchange system. FIGS. 5A-5C are screen displays illustrating representative Web pages of various aspects of the method 400. The following discussion refers to FIG. 4 to describe the various stages of the method 400, and FIGS. 5A-5C to provide examples of representative Web pages in accordance with aspects of the method 400. In other embodiments, the method 400 can include different steps and/or the screen displays illustrated in FIGS. 5A-5C can have different arrangements and/or content.

In block 402, the applicant accesses a new account Web page from the currency exchange system to begin the application process. FIG. 5A, for example, is one particular embodiment of an application or “Account Sign Up” page 500. The application page 500 can include a number of personal identification fields 510 for entry of the applicant's personally-identifying information. In the illustrated embodiment, for example, the personal identification fields 510 include first and last name, company name, country of residence, address, telephone and fax numbers, and a company contact person (if applicable). In other embodiments, the personal identification fields 510 can include other arrangements and/or request different information from the applicant.

The application page 500 can also include transaction detail fields 520 for entry of information regarding the applicant's desired currency exchange transaction preferences. In the illustrated embodiment, for example, the transaction detail fields 520 include transaction range, transaction frequency, and the particular day on which the applicant normally places the currency exchange request. In other embodiments, the transaction detail fields 520 can include other arrangements and/or request different information from the applicant.

In block 404, the applicant can link external financial accounts to the newly created user account with the currency exchange system. The external financial accounts can be used to fund the applicant's new account with the currency exchange system, and the external accounts can be used to receive exchanged funds after a currency exchange transaction. Referring to FIG. 5B, for example, an external account page 530 can include first account information fields 540 for entry of details regarding a first external financial account of the applicant based on a first currency, and second account information fields 550 for entry of details regarding a second external financial account of the applicant based on a second, different currency. In the illustrated embodiment, for example, the first account information fields 540 include the institution name, account number, and transit/routing number of a Canadian dollar account of the applicant. The second account information fields 550 include the institution name, account number, and transit/routing number of a U.S. dollar account of the applicant. As mentioned previously, the two different accounts may be with the same financial institution (e.g., the Bank of Montreal), or the accounts may be at different financial institutions (as shown in FIG. 5B). Further, as discussed previously, the external accounts can be based on any type of currency, and are not limited to Canadian and U.S. dollar accounts.

After entry of the external account information, the method 400 continues at block 406 with verification of the applicant's external account information. After successfully verifying the account information, the method 400 can continue at block 408 with display of an approval message. Referring to FIG. 5C, for example, an approval Web page 560 in accordance with one embodiment of the disclosure can include notification that the applicant's account information has been approved and verified. The approval page 560 can also include a user identification field 562 and a password field 564 for the applicant to select a user ID and password for the new account.

In several embodiments, the method 400 may also include one or more disclosure steps in which the applicant is provided with a number of legal disclosures for review, such as those required by federal and international banking laws, money transfer regulations, anti-money laundering policies, privacy policies, and other necessary regulatory disclosures. In some embodiments, one or more disclosure pages may also include an electronic notice and consent agreement that the applicant must view and accept (e.g., by clicking a checkbox to affirm that the applicant has read and accepted the terms of the agreement). After block 408, the method 400 ends.

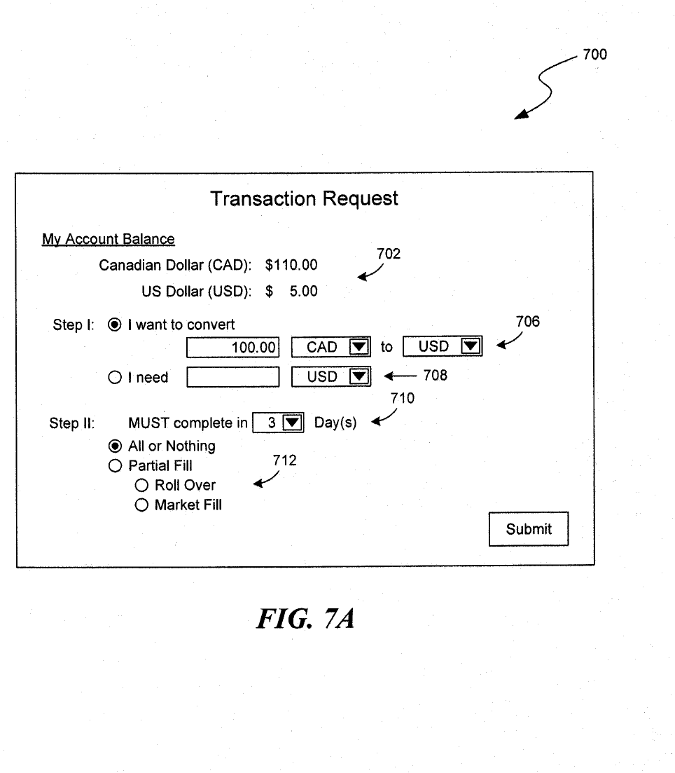

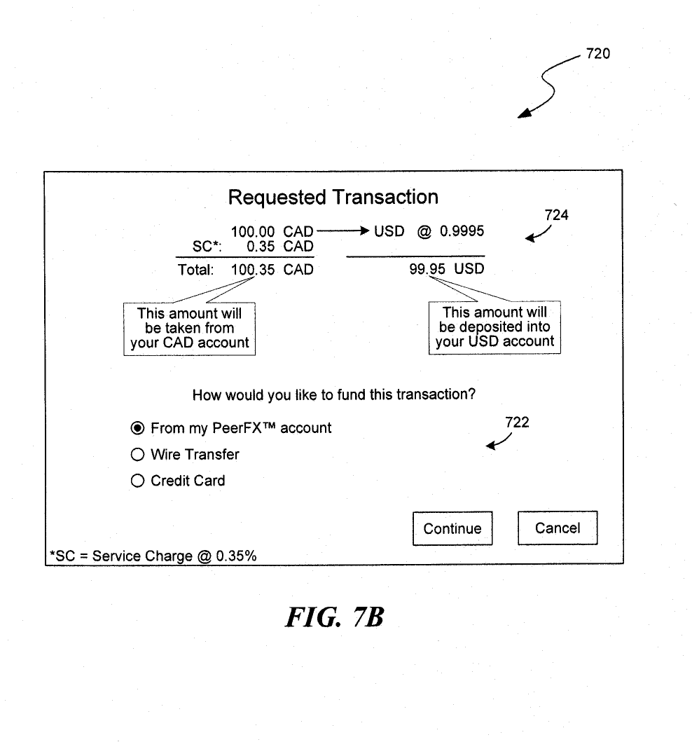

FIG. 6 is a flow diagram illustrating a method or routine 600 for conducting a currency or value exchange transaction between two or more persons or other entities via peer-to-peer trading in accordance with an embodiment of the disclosure. In one aspect of this embodiment, some portions of the method 600 may be performed by a currency exchange system and other portions may be performed by a user. In other embodiments, however, various portions of the method 600 can be performed by other entities. FIGS. 7A and 7B are screen displays illustrating representative Web pages of various aspects of the method 600. The following discussion refers to FIG. 6 to describe the various stages of the method 600, and FIGS. 7A and 7B to provide examples of representative Web pages in accordance with aspects of the method 600. In other embodiments, the method 600 can include different steps and/or the screen displays illustrated in FIGS. 7A and 7B can have different arrangements and/or content.

In block 602, the user accesses a Web site of the currency exchange system and, after successfully logging in to the system, submits a transaction request to begin the transaction process. The transaction request can include a particular currency need for the user and a desired period of time in which the user wishes the transaction to be completed. FIG. 7A, for example, is one particular embodiment of a transaction request page 700 for entry of information regarding the user's currency needs and desired currency exchange preferences. The transaction request page 700 can include an account balance field 702 showing the user's current account balance(s). In the illustrated embodiment, for example, the user has an account balance in both a Canadian dollar account (e.g., $110.00) and a U.S. dollar account (e.g., $5.00). In one embodiment, these balances can reflect the particular user's account balance with the currency exchange system itself. In another embodiment, however, the balances may reflect the balances in the user's linked external financial accounts. In still other embodiments, the transaction request page 700 may not include the account balance fields 702.

The transaction request page 700 can also include currency exchange fields 704. The currency exchange fields 704 include a first exchange field 706 in which the user can select a desired quantity of currency to exchange. In the illustrated embodiment for example, the user has requested an exchange of $100.00 Canadian dollars to U.S. dollars. In other embodiments, however, the user can select any amount of currency to convert from one type of currency to any other type of currency (e.g., Euros, British pounds, Japanese Yen, Swiss Francs, Mexican Pesos, or any other suitable currency). In still other embodiments, the user may select an amount of currency to convert from one type of currency (e.g., U.S. dollars) to two or more other types of currencies (e.g., a portion in Canadian dollars, and a portion in Euros). It will be appreciated that because the currency exchange system conducts transactions using peer-to-peer technology, the particular types and volumes of currency exchange transactions that may be performed are only limited based on the availability of matching respective currency exchange transactions. Further details regarding transaction matching and optimization features will described below.

The currency exchange fields 704 can also include a second exchange field 708 in which the user can enter a particular currency need in a selected type of currency. For example, rather than requesting a conversion of $100.00 Canadian dollars to U.S. dollars, the user can request a particular quantity of currency (e.g., $100.00 U.S. dollars). As described in greater detail below, this currency request can be funded using various methods before the transaction is completed.

The transaction request page 700 can further include a transaction timing field 710 in which the user can select a desired period of time in which the user wishes the transaction to be completed. In this particular embodiment, for example, the user can select a period of between 1 to 3 business days for the transaction to be completed. In several embodiments, a waiting period may be necessary in order to create a sufficiently large volume of individual requests to exchange within the currency exchange system. In other embodiments, however, the waiting period times can vary or there may not be any waiting period for such transactions.

In several embodiments, an exchange rate may be locked in for the user's transaction as soon as the user enters all the necessary information on the transaction request page 700 (and provided that the user has the required funds to conduct the transaction). If the user does not have the required funds in the user's account at the currency exchange system, the currency exchange system may provide a period of time (e.g., one business day) for the user to fund the account before cancelling the transaction (and the locked-in exchange rate). In other embodiments, different arrangements may be used to provide the user with a locked-in, guaranteed, or preferred exchange rate for a transaction. In still other embodiments, however, the exchange rate may not be locked in at this stage, or at all. Because the exchange rate movement between the most currency pairs (e.g., the Canadian dollar and the U.S. dollar) during the span of a single day is negligible, however, the impact of a delay of at least approximately 24 hours between order placement and order fulfillment is expected to be immaterial for most users.

The transaction request page 700 may also include a transaction execution field 712 in which the user can make a selection as to whether the requested transaction should be completed based on an “all or nothing” model, or based on a “partial fill” model. In the particular embodiment illustrated in FIG. 7A, for example, the user has selected a three-day time period and the “all or nothing” button. Accordingly, the user's request for conversion of $100.00 Canadian dollars to U.S. dollars should be fully completed within three business days and, if this request cannot be fully satisfied, the user would like the transaction cancelled. In another embodiment, however, the user may select the “partial fill” model in which the exchange request can be rolled over to one or more subsequent days if the request cannot be filled within the three-day time period. Alternatively, the exchange request may be completed using a “market fill” process in which at least a portion of the currency exchange is completed using a third-party broker, rather than the currency exchange system's peer-to-peer trading. In still other embodiments, the transaction request page 700 can include other arrangements and/or request different transaction request information from the user.

In block 604, the user selects a funding method for the desired currency exchange transaction. As described previously, for example, one or more external financial accounts can be used to fund the user's account with the currency exchange system and/or to fund specific transaction requests. FIG. 7B, for example, is one particular embodiment of a transaction funding page 720 for entry of funding information associated with the user's desired transaction. The transaction funding page 720 can include a funding selection field 722 in which the user can select how to fund the current transaction. In the illustrated embodiment, for example, the user has selected to fund the current transaction with funds from the user's currency exchange system (e.g., PeerFX™) account. If the user's currency exchange account does not have sufficient funds for the transaction, the user may be asked to fund at least a portion of the transaction with another funding source. In other embodiments, the user may elect to fund the transaction using a wire transfer or a credit card. In still other embodiments, the funding selection field 722 may include other suitable options with which the transaction can be funded,

In block 606 of the method 600, the currency exchange system obtains the current market rate for the desired currency exchange transaction and provides the quoted rate to the user. In one embodiment, for example, the currency exchange system obtains the so-called “noon rate.” In another embodiment, however, the currency exchange system may use the so-called “closing rate.” Regardless of which rate is chosen, the method 600 utilizes the median rate for conducting currency exchange transactions. In many conventional currency exchange transactions, the bank or dealer “sells” you foreign currency at one rate, but will “buy” the same foreign currency back at a lower rate. The difference between these rates is known as the bid/ask spread. In many transactions, the bid/ask spread can be as much as 3% (or even more) per transaction. In contrast, the method 600 utilizes the median rate for transactions-buyers and sellers exchange currency at the same rate. Embodiments of the method 600 are accordingly expected to save users of the currency exchange system up to 80% in transaction fees per transaction.

In decision block 608, the method 600 continues with the user confirming the rate and other details of the transaction, and deciding whether to proceed with the transaction. The transaction funding page 720, for example, can include a transaction overview field 724 that provides various details of the requested transaction (e.g., the user-provided details from the transaction request page 700 of FIG. 7A along with the market rate obtained in block 606). For instance, continuing with the previous example, the transaction overview field 722 provides details regarding the user's request to convert $100.00 Canadian dollars to U.S. dollars. In one particular aspect of this embodiment, the transaction overview field 724 provides a quote to the user of the current exchange rate (e.g., 0.9995) between the selected currencies and an approximate final value (minus a service charge on the amount the user would like to convert) that will be deposited into the user's selected external financial account (e.g., the user's U.S. dollar account). Although the service charge in the illustrated embodiment is 0.35%, this value can vary. Moreover, in at least some embodiments, there may be no service charge for the transactions. In other embodiments, the transaction funding page 720 can include other arrangements and/or include different features. In still other embodiments, the funding selection field 722 and the transaction overview field 724 may be on separate Web pages presented to the user.

If the user agrees with the various transaction details and wishes to proceed, the method 600 continues at block 610. If the user wishes to change one or more details of the transaction, however, the method 600 returns to block 602 and a new transaction request process can begin.

In block 610, the currency exchange system sends an order/transaction confirmation to the user via electronic mail. The method 600 can also include entering the transaction details into a user record database. The method 600 continues in block 612 with the currency exchange system receiving funds from the user. As discussed previously, the user can fund the transaction in a variety of different ways. For example, in several embodiments, the user can fund the transaction with existing funds from the user's currency exchange system account. One advantage to using funds held in the user's currency exchange system account is that the user's transaction will not be subject to any holding periods associated with transferring funds from external accounts, and thus the user will receive his or her exchanged funds faster. If such funds are not available or insufficient, however, the user can be directed to his or her respective online banking or financial account Web site, the PayPal® Web site, or another selected electronic fund transfer system Web site to send funds to the user's currency exchange system account via an electronic funds transfer.

In several embodiments, a bill payment system may be used to make a “payment” to the user's currency exchange system account to fund the transaction. In this embodiment, the currency exchange system receives confirmation of the selected transaction information (at block 608) and issues an invoice to the user via electronic mail (at block 610). The system then directs the user to his or her selected bill payment system to pay the invoice, which will in turn “fund” the user's currency exchange system account. This process can happen in real time without significant delays between the issuance of the invoice and funding of the currency exchange system account. The only delay in this particular embodiment may be as a result of delays associated with the user's bill payment system. For example, many bill payment systems require at least one business day to make a payment to a third party. In yet another embodiment, the user can fund the transaction by mailing a check to an entity operating the currency exchange system. In still further embodiments, the transaction may be funded using other suitable methods. After completing the necessary funding step(s), the user will be sent a notification via electronic mail that the transaction request has been accepted once the currency exchange system receives the funds (block 612) from the user's external financial account.

In block 614, the currency exchange system enters the user's request into an aggregation or pool of other user requests and funds for currency exchange transactions. In block 616, the currency exchange system performs matching of the user requests. In the method 600, the matching process in done once daily. In other embodiments, however, the frequency of the matching process in block 616 can vary. For example, if the volume of transaction requests in the currency exchange system is sufficient, the matching process in block 616 may occur multiple times per day. In other embodiments, however, the occurrence of the matching process may be different.

The matching process in block 616 can be performed using a variety of different methods and can be based, to varying degrees, upon a number of different factors. In some cases, for example, the matching process may include simply looking for corresponding requests from different users and matching such requests together to facilitate the exchanges (e.g., a request from a first user wishing to exchange $100 Canadian dollars to U.S. dollars is matched with a request from a second user wishing to exchange $100 U.S. dollars to Canadian dollars).

In many cases, however, there will not be a large enough volume of user requests and exact matches between the various requests to match each request. Accordingly, the method 600 can include pooling all of the respective requests and applying one or more factors to optimize processing and help ensure that each user's request can be processed in a timely and efficient manner. Prioritizing the factors can help ensure that the largest total number of transactions and total transaction volume are processed during each processing cycle. In several embodiments, for example, the following P2P currency pooling algorithm may be used:

Currency X Pool: X₁+X₂+X₃ . . . +Xₘ=X (1)

Currency Y Pool: Y₁+Y₂+Y₃ . . . +Yₕ=Y (2)

where X₁ . . . Xₘ equals the transaction amount (after rate consideration) in Currency X for User 1 . . . User m, and Y₁ . . . Yₕ equals the transaction amount (after rate consideration) in Currency Y for User 1 . . . User h,

Based on the values X and Y from Equations (1) and (2):

Total Currency X amount demand on Day n=Xⁿ (3)

Total Currency Y amount demand on Day n=Yⁿ (4)

and

Excess Currency X amount demand on Day n=E_{X}ⁿ (5)

Excess Currency Y amount demand on Day n=E_{Y}ⁿ (6)

Based on the above results from Equation (3) to Equation (6):

### On Day n:

If Xⁿ>Yⁿ: then, [Xⁿ−Yⁿ]+E_{X}ⁿ⁻¹=E_{X}ⁿ (7)

If Xⁿ<Yⁿ: then, [Yⁿ−Xⁿ]+E_{Y}ⁿ⁻¹=E_{Y}ⁿ (8)

If Xⁿ=Yⁿ: then, E_{X}ⁿ⁻¹=E_{X}ⁿ or E_{Y}ⁿ⁻¹=E_{Y}ⁿ (9)

### On Day n+1:

If Xⁿ⁺¹>Yⁿ⁺¹: then, [Xⁿ⁺¹−Yⁿ⁺¹]+E_{X}ⁿ=E_{X}ⁿ⁺¹ (10)

If Xⁿ⁺¹<Yⁿ⁺¹: then, [Yⁿ⁺¹−Xⁿ⁺¹]+E_{Y}ⁿ=E_{Y}ⁿ⁺¹ (11)

If Xⁿ⁺¹=Yⁿ⁺¹: then, E_{X}ⁿ⁺¹=E_{X}ⁿ⁺¹ or E_{Y}ⁿ=E_{Y}ⁿ⁺¹ (12)

In addition, as discussed above, various factors can be taken into account to optimize the various transaction requests in each processing cycle. In one embodiment, for example, the weighted average of the transaction amount (after rate consideration) in Currency X from User 1 . . . User m is as follows:

(N*W_{N}+V*W_{V}+R*W_{R}+C*W_{C}+M*W_{M})(X₁)=W_{X1} (13)

(N*W_{N}+V*W_{V}+R*W_{R}+C*W_{C}+M*W_{M})(Xₘ)=W_{Xm} (14)

The weighted average of the transaction amount (after rate consideration) in Currency Y from User 1 . . . User m is as follows:

(N*W_{N}+V*W_{V}+R*W_{R}+C*W_{C}+M*W_{M})(Y₁)=W_{Y1} (15)

(N*W_{N}+V*W_{V}+R*W_{R}+C*W_{C}+M*W_{M})(Yₕ)=W_{Yh} (16)

In Equations (13) to (16), N is the total number of transactions, V is the total transaction volume, R is the user or customer rating, C is the chronological priority, and M is one or more miscellaneous factors. Further, W_{N} is the selected weight given to the number of transactions, W_{V} is the weight given to the transaction volume, W_{R} is the weight given to customer rating, W_{C} is the weight given to chronological priorities, and W_{M} is the weight given to the one or more miscellaneous factors.

The optimization process proceeds by (a) sorting W_{X1} to W_{Xm} and W_{Y1} to W_{Yh} in a preferred order, and (b) processing transactions based on this order. It should be appreciated that the above algorithm is just one representative example of a pooling and optimization algorithm for use with the method 600, and one or more aspects of the algorithm described above can be modified and/or omitted in other embodiments. For example, a different combination of weighted factors may contribute to the weighted average.

Moreover, in still other embodiments different techniques may be used to prioritize and/or optimize the transaction requests. For example, the transaction requests can be prioritized based merely on (a) the chronological order in which the request was received, (b) the size of the transaction request, and (c) customer preference (e.g., preferred or frequent users get first priority for their exchange requests). These factors are merely representative of certain factors that may be considered when optimizing the transaction requests, and in other embodiments different factors may be used.

Although only a single factor may be used during processing (e.g., process all requests chronologically based on the order in which the orders were received, process largest requests first and progressively process smaller requests, etc.), there can be issues with using just a single factor to prioritize processing. For example, if too many large requests are processed first, there may not be enough funds at the end of the cycle to satisfy the small requests. This same issue can arise if the requests are processed merely based on the order in which the requests were received.

In many cases, regardless of the process or technique used to prioritize and/or optimize the individual transactions, the requests for particular currency pairs in a given processing cycle are not going to match and there will be an imbalance in the demand/supply between the various currency pairs being exchanged. For example, in a given processing cycle, there may be an excess of Canadian dollars, while in a subsequent processing cycle there may be an excess of U.S. dollars.

There are several techniques to deal with such imbalances. In the method 600, for example, the excess funds can be rolled over into the next day's cycle (as shown by the arrow 617) and can be used to fill subsequent transactions on that day. As discussed previously, the typical waiting period for processing of a currency exchange transaction in the method 600 is between one to three business days. Accordingly, rolling over the excess funds into the next processing cycle can help ensure that at least approximately all of the exchange requests are completed within the three business day window.

In another embodiment, excess demand can be fulfilled using a third-party broker. In this embodiment, excess funds that the currency exchange system is not able to exchange using peer funds can be grouped together for an outside market exchange. The pooling effect of the excess funds can allow the entity operating the currency exchange system to trade in the foreign exchange (the so-called “forex”) market, on behalf of the users, at a significantly better exchange rate than what each user could have realized alone. Thus, although the currency exchange transactions may not be completed at the median rate, the exchange rate for these transactions is still expected to be significantly better than the current bid/ask spread charged by banks and conventional exchange dealers. Furthermore, in some embodiments, the method 600 may include giving users an option to wait one or more additional business days for completion of their transaction within the peer-to-peer model before sending their requests to the third-party broker.

Although it is unlikely, in at least some embodiments one or more transaction requests may still not be filled within the corresponding transaction window. In such cases, the respective user can be informed (e.g., via electronic mail) that the user's particular request cannot be satisfied. The user can resubmit another request for the same amount or submit a different request. The entity operating the currency exchange system, however, typically does not fulfill the user's request outside of the normal models described above. Further, the entity operating the currency exchange system generally does not provide a “guarantee” that each currency exchange request will be fulfilled within a given period of time.

After matching and processing the pool of currency exchange requests, in block 618 the currency exchange system disburses the converted funds (minus the service fee) to the individual users and sends an invoice to the user (e.g., via electronic mail) notifying the user of the completed transaction. The converted funds can be disbursed from the currency exchange system in a variety of different ways. For example, in several embodiments a lump sum of the converted funds from a particular processing cycle are remitted to a payment solution system (e.g., the payment solution component 314 of FIG. 2) along with a data file including details of how the payment solution system should disburse the converted funds. The payment solution system then disburses the funds to each user's appropriate external account. One advantage of using a payment solution system to disburse the converted funds is that it can minimize and/or eliminate a number of regulatory reporting steps required for each individual transaction.

As discussed previously, however, the payment solution system is an optional component and may not be used in some embodiments. Accordingly, in several embodiments the method 600 can include disbursing the converted funds (minus the service fee, if applicable) directly into an appropriate external account of the user. For instance, continuing with the previous example described above with reference to FIGS. 7A and 7B, the currency exchange system can deposit the converted funds in U.S. dollars (e.g., $99.95) into an external U.S. dollar account of the user (e.g., a bank or financial institution account, a credit card account, a brokerage account, a PayPal® account, etc.).

In another embodiment, the user can be mailed a check in an amount corresponding to the converted funds. In still another embodiment, the converted funds can be deposited into the user's account with the currency exchange system, and can be accessed at a later point in time by the user and converted into another currency, or transferred to an external financial account of the user. In another embodiment, the currency exchange system can “pay off” a balance on a user's credit card account. In one particular example, a user may use a U.S. dollar credit card account to make purchase(s) in a foreign country (e.g., Canada). The user can then use the currency exchange system to convert the exact amount of money that he or she needs to pay off the credit card balance and, after conversion of the funds, the currency exchange system to make a payment to the credit card account. In still another embodiment, the converted funds may be disbursed to a third-party account (e.g., an external financial account, a different user account at the currency exchange system, etc.) not controlled by the user. In yet other embodiments, the converted funds may be disbursed to the user or a third-party using other suitable methods and/or processes.

In block 620, the method 600 can include sending out an electronic report of each transaction to the appropriate regulatory agency. This report can be configured to include all of the information required by the particular regulatory agency for a particular transaction. For example, there are particular reporting requirements for transactions exceeding a given amount (e.g., transactions of $10,000 or more). The electronic report in block 620 can be modified to meet both current and future regulatory requirements. Furthermore, this portion of the method 600 may be completed at one or more different stages of the method 600. For example, certain countries may have different regulatory requirements and require such reports at different stages in the method 600 (e.g., at the initial transaction request stage in block 602). After block 620, the method 600 ends.

### C. Additional Embodiments of Peer-to-Peer Currency or Value Exchange Systems and Associated Methods

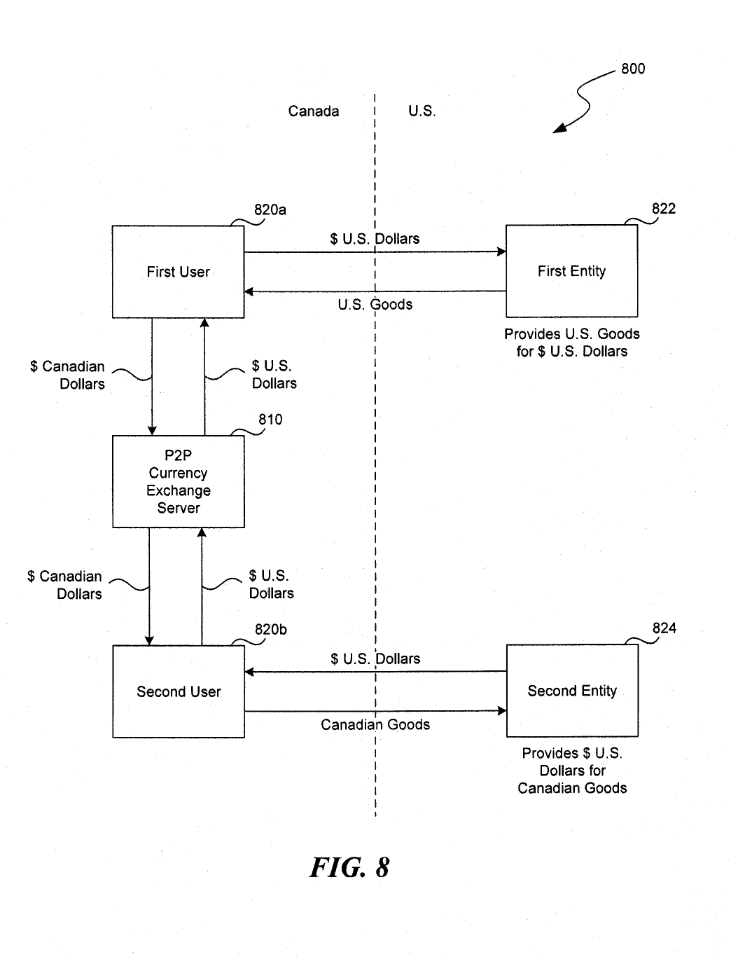

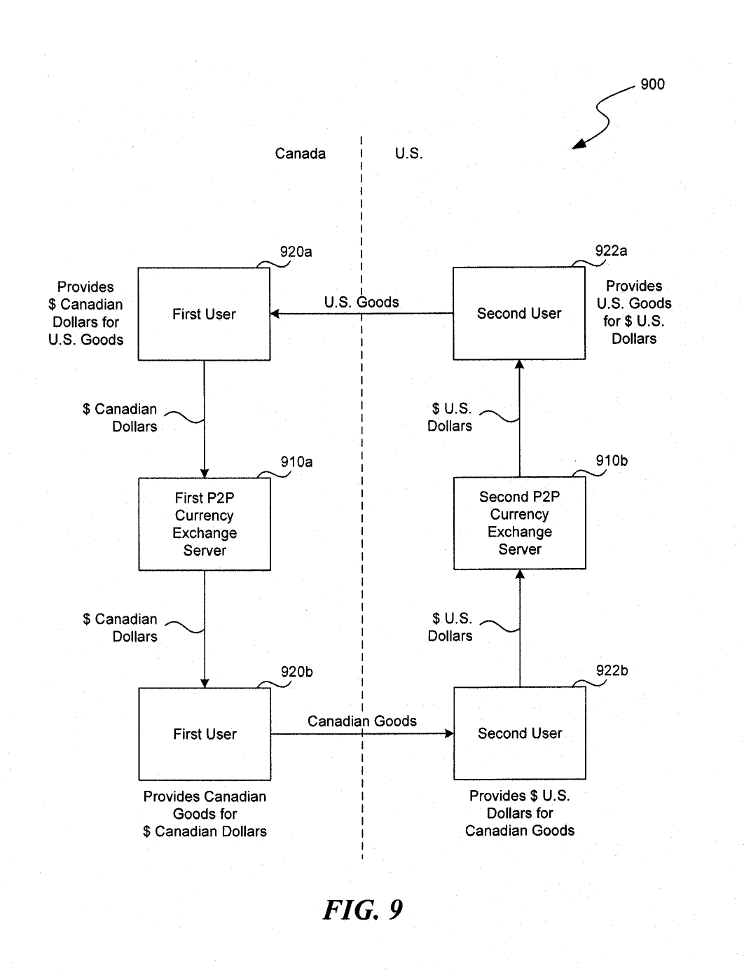

FIGS. 8 and 9 illustrate additional embodiments of currency or value exchange systems configured in accordance with embodiments of the disclosure. The systems illustrated in FIGS. 8 and 9 can include many features generally similar to the systems and methods described above with reference to FIGS. 1-7B.

FIG. 8, for example, is a block diagram illustrating data flow between various components of a P2P currency or value exchange system 800 in some embodiments. The system 800 is configured to match the supply of a particular currency (e.g., U.S. dollars) within a first country (e.g., Canada) to the demand for that particular currency (e.g., U.S. dollars) within the first country (e.g., Canada). The system 800 is accordingly configured as a so-called “within border currency complementing” model. In this way, the system 800 can function without executing any cross-border currency exchange transactions. In several embodiments, this can eliminate the need for banks or financial institutions in a second, foreign country (e.g., the U.S.) to have accounts available to users of the system 800 based on a currency of the first country (e.g., Canadian dollar accounts in a U.S. bank or financial institution).

Referring to the particular arrangement shown in FIG. 8, the system 800 can include a currency exchange server 810 and multiple users 820 (two are shown as a first user 820a and a second user 820b) interconnected with the currency exchange server 810 via a communication network (not shown). The currency exchange server 810 and users 820 can be generally similar to the currency exchange server 310 and users 320 described above with reference to FIG. 3. Further, the currency exchange server 810 and the first and second users 820a and 820b are all located in the same country (e.g., Canada). As discussed above, this can eliminate cross-border currency exchange transactions.

The system 800 can further include a first entity 822 (egg., a U.S. business, supplier, vendor, individual, etc.) that provides U.S. goods to the first user 820a in exchange for U.S. dollars. The system 800 also includes a second entity 824 (e.g., a U.S. business, individual, etc.) that provides U.S. dollars to the second user 820 in exchange for Canadian goods. The first and second users 820a and 820b accordingly use the currency exchange server 810 and associated components to conduct currency exchange transactions as part of each of their respective courses of business to facilitate the flow of currency and goods between the respective parties. In the illustrated embodiment, the first and second entities are not interconnected with or associated with the currency exchange server 800.

It will be appreciated that for purposes of brevity and clarity, the block diagram of FIG. 8 is referred to in its entirety as illustrating a currency or value exchange system 800. It will be appreciated, however, that this description may also be applied to various individual components or subsets of components of the block diagram of FIG. 8 (e.g., the currency exchange server and the first and second users 820a and 820b). Furthermore, the arrangement of the various components in the system 800 is merely intended to demonstrate one possible arrangement of various components of a currency or value exchange system configured in accordance with aspects of the disclosure, and in other embodiments the system 800 can have a variety of other arrangements and/or features. Moreover, the use of Canadian and U.S. currency and goods is merely representative of one particular cross-border arrangement, and in other embodiments the system 800 can be used with any suitable arrangement for the exchange of currency and goods between respective countries.

FIG. 9 is a block diagram illustrating data flow between various components of a P2P currency or value exchange system 900 in accordance with some embodiments. The system 900 is configured to match foreign obligations of a first entity in a first country with foreign obligations of a second entity in a second country. By way of example, a Canadian entity pays off a U.S. entity's obligation to a Canadian supplier, and in return the U.S. entity pays of the Canadian entity's obligation to a U.S. supplier. The system 900 is accordingly configured as a so-called “cross-border obligation complementing” model. In this way, the system 800 match cross-border obligations between various entities using a peer-to-peer model.

Referring to FIG. 9, the system 900 can include a first currency exchange server 910a in a first country (e.g., Canada) and a second currency exchange server 910b in a second country (e.g., the U.S.). The system 900 can also include multiple first users 920 (two are shown as first user 920a and first user 920b) interconnected with the first currency exchange server 910a via a communication network (not shown). The first users 920a and 920b are both located in the first country. The system 900 also include multiple second users 922 (two are shown as second user 922a and second user 920b) interconnected with the second currency exchange server 920a via a communication network (not shown). The second users 922a and 922b are both located in the second country. The currency exchange servers 910 and users 920 and 922 can be generally similar to the currency exchange server 310 and users 320 described above with reference to FIG. 3.

As with the systems discussed above, it will be appreciated that for purposes of brevity and clarity, the block diagram of FIG. 9 is referred to in its entirety as illustrating a currency or value exchange system 900, and this description may also be applied to various individual components or subsets of components of the block diagram of FIG. 9. In addition, the arrangement of the various components in the system 900 is merely intended to demonstrate one possible arrangement of various components of a currency or value exchange system configured in accordance with aspects of the disclosure, and in other embodiments the system 900 can have a variety of other arrangements and/or features. Moreover, the use of Canadian and U.S. currency and goods is merely representative of one particular cross-border arrangement, and in other embodiments the system 900 can be used with any suitable arrangement for the exchange of currency and goods between respective countries.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

In general, the above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments. Any patents and applications and other references noted above, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description describes certain embodiments of the invention, and describes the best mode contemplated, no matter how detailed the above appears in text, the invention can be practiced in many ways. Details of the data collection and processing system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, a number of aspects of the invention may be embodied in a computer-readable medium. Accordingly, the inventors reserve the right to add additional claims after filing the application to pursue such additional claim forms for other aspects of the invention.

I/We claim:

1. A computer-implemented method of facilitating a currency exchange transaction between multiple users of a computerized peer-to-peer (P2P) currency exchange system, the method comprising:
receiving user instructions at the currency exchange system for a currency exchange transaction, wherein individual user instructions include (a) a selected amount of money to be converted, (b) specification of a first currency in which the funds in which the funds are to be provided, (c) specification of a second currency different from the first currency into which the funds are to be converted, and (d) specification of a period of time in which the transaction is to be completed;
funding corresponding user accounts at the currency exchange system based, at least in part, on the respective user's selected amount of money to be converted and a current exchange rate between the first currency and the second currency;
aggregating funds from the corresponding user accounts at the currency exchange system;
after aggregating the funds, matching user requests for a conversion of funds into a selected currency pairing, wherein the matching process is based, at least in part, on one or more predetermined matching parameters; and
for each matched user request, electronically transferring the converted funds to a corresponding external account of the respective user.

2. The computer-implemented method of claim 1 wherein matching user requests for a conversion of funds into a selected currency pairing comprises prioritizing the user requests for a particular processing cycle based on at least one of the following matching parameters—
the total number of transactions;
a total transaction volume;
a user or customer rating; and
a chronological order in which the user instructions were received.

3. The computer-implemented method of claim 2, further comprising assigning a weighting factor to individual matching parameters relative to the other matching parameters before prioritizing the user requests in a given processing cycle.

4. The computer-implemented method of claim 2 wherein a first set of matching parameters is used for a first processing cycle, and wherein a second set of matching parameters different from the first set of matching parameters is used for a second processing cycle.

5. The computer-implemented method of claim 1 wherein aggregating funds from the corresponding user accounts and matching user requests for conversion comprises a first processing cycle, and wherein excess aggregated funds that are not transferred to external accounts of the users are rolled over into a second, subsequent processing cycle.

6. The computer-implemented method of claim 1 wherein transferring the converted funds to an external account of the respective user occurs at least 24 hours after receiving user instructions at the currency exchange system.

7. The computer-implemented method of claim 1 wherein transferring the converted funds to an external account of the respective user occurs no more than three business days after receiving user instructions and funds at the currency exchange system.

8. The computer-implemented method of claim 1 wherein transferring the converted funds to a corresponding external account of the respective user includes transferring a lump sum of the converted funds to an external payment processing entity, and wherein the payment processing entity disburses the converted funds to the corresponding external accounts of the respective users.

9. The computer-implemented method of claim 1, further comprising registering multiple users with the currency exchange system before receiving user instructions at the currency exchange system for a currency exchange transaction, wherein each user is assigned an account with the currency exchange system.

10. The computer-implemented method of claim 9, further comprising linking a first and a second external financial account of a user with the respective user's account at the currency exchange system, wherein the first external financial account is based on the first currency and the second external financial account is based on the second currency.

11. The computer-implemented method of claim 1, further comprising receiving confirmation at the currency exchange system that the funds have been received into corresponding user accounts from an external financial account of the corresponding user before aggregating funds from the corresponding user accounts.

12. The computer-implemented method of claim 11, further comprising linking a first and a second external financial account of a user with the respective user's account at the currency exchange system, wherein the first external financial account is based on the first currency and the second external financial account is based on the second currency, and wherein transferring the converted funds to a corresponding external account of the respective user comprises transferring the converted funds to the external financial account based on the appropriate currency.

13. The computer-implemented method of claim 1, further comprising electronically reporting details of each completed transaction to one or more regulatory agencies.

14. The computer-implemented method of claim 1 wherein funding corresponding user accounts at the currency exchange system includes using an electronic funds transfer from an external financial account of the corresponding user to fund the user's account at the currency exchange system.

15. The computer-implemented method of claim 1 wherein receiving user instructions at the currency exchange system for a currency exchange transaction includes electronically receiving user instructions from remote client devices via a communication network.

16. The computer-implemented method of claim 1, further comprising cancelling a particular user request if the transaction request is not matched within the period of time in which the transaction is to be completed, and wherein unmatched user requests are not fulfilled by the currency exchange system.

17. A peer-to-peer (P2P) currency exchange system for facilitating foreign currency exchange transactions between multiple users the system comprising:
one or more data storage components configured to store user account information, user instructions for currency exchange transactions, and one or more predetermined transaction matching parameters; and
one or more data processing components coupled to the one or more data storage components, the one or more data processing components configured to—
process user instructions for currency exchange transactions, wherein the individual user instructions include a selected amount of money to be converted from a first currency to a second, different currency and a time period in which the transaction is to be completed;
debit funds from one or more external financial accounts of each user to fund the respective user's account at the currency exchange system;
group the user requests and funds from corresponding user accounts;
match two or more of the grouped user requests for a conversion of funds into a selected currency pairing based, at least in part, on the one or more predetermined transaction matching parameters; and
disburse the converted funds to a corresponding external financial account of the corresponding user.

18. The currency exchange system of claim 17 wherein the one or more data processing components are further configured to:
process an application of an applicant to become a user of the currency exchange system;
upon approval of the application, link a first external financial account and a second external financial account of the of the new user with the user's account at the currency exchange system, wherein the first external financial account is based on the first currency and the second external financial account is based on the second currency.

19. The currency exchange system of claim 17 wherein the one or more predetermined transaction matching parameters include at least one of the total number of transactions during a particular processing cycle, a total transaction volume during the processing cycle, a user or customer rating, and a chronological order in which the user instructions were received.

20. The currency exchange system of claim 17 wherein the one or more data processing components are further configured to cancel a particular user request if the request is not matched within the period of time in which the transaction is to be completed.

21. The currency exchange system of claim 17 wherein disbursing the converted funds to a corresponding external financial account of the corresponding user occurs between at least approximately one business day and three business days after processing user instructions for the particular transaction.

22. The currency exchange system of claim 17 wherein the one or more data processing components are further configured electronically notify users of completion of currency exchange transactions and disbursement of funds to the particular user's external financial account.

23. One or more computer-readable media collectively storing computer-executable instructions that, when executed, perform a method for facilitating a foreign currency exchange transaction between multiple entities, the method comprising:
registering multiple users with the currency exchange system, wherein each user is assigned an account with the currency exchange system;
receiving at the currency exchange system a plurality of user requests for currency exchange transactions, wherein the individual requests include a selected amount of money to be converted from a first currency to a second currency, and a desired period of time in which the transaction is to occur;
debiting funds from one or more external financial accounts of each user to fund the respective user's account at the currency exchange system based, at least in part, on the selected monetary value of the respective user's request;
pooling funds from multiple transaction requests together at the currency exchange system and, after pooling the requests, processing user requests for a conversion of funds in a selected currency pairing based, at least in part, on one or more predetermined factors; and
transferring converted funds to a corresponding external account of the respective user.

24. A system for facilitating a peer-to-peer (P2P) foreign currency exchange transactions, the system comprising:
means for receiving user transaction instructions at a currency exchange system, wherein individual user instructions include (a) a selected amount of money to be converted, (b) specification of a first currency in which the funds in which the funds are to be provided, (c) specification of a second currency into which the funds are to be converted, and (d) specification of a period of time in which the transaction is to be completed;
means for funding corresponding user accounts at the currency exchange system based, at least in part, on the respective user's selected amount of money to be converted and a current exchange rate between the first currency and the second currency;
means for matching multiple user requests for a conversion of funds into a selected currency pairing based, at least in part, on one or more predetermined matching factors; and
means for transferring the converted funds to corresponding external accounts of the respective users.

25. The system of claim 24, further comprising means for registering multiple users with the currency exchange system and assigning each user an account with the currency exchange system.

26. A computer-implemented method of facilitating a currency exchange transaction between multiple users of a peer-to-peer (P2P) currency exchange system, wherein the currency exchange system includes at least one currency exchange server coupled with multiple remote client devices via a public computer network, and wherein the method comprises:
receiving from a user instructions for a currency exchange transaction, wherein the user instructions include a selected amount of money to be converted from a first currency to a second currency, a desired period of time in which the transaction is to occur, and a specification of one or more external financial accounts of the user from which at least a portion of the particular user's transaction will be funded;
providing the instructions for the currency exchange transaction from a remote client device to the currency exchange server via the public computer network, wherein the instructions cause at least one of the currency exchange server and corresponding remote client devices to—
pool funds from multiple transaction requests together at the currency exchange system and, after pooling the requests, process transaction requests for a conversion of funds in a selected currency pairing based, at least in part, on one or more predetermined factors; and
transfer converted funds to a corresponding external account of the respective user;
receiving at the remote client device confirmation that the converted funds were transferred to the external account of the user; and
displaying by the remote client device the confirmation to the user.

27. The computer-implemented method of claim 26, further comprising:
receiving application instructions at the remote client device from an applicant to become a user of the currency exchange system;
providing the application instructions to the currency exchange server; and
receiving at the remote client device confirmation of approval of the application before providing instructions for the currency exchange transaction to the currency exchange server.
